(19) United States
(12) Patent Application Publication
(10) Pub. No.: US 2010/0300768 A1
(43) Pub. Date: Dec. 2, 2010

(54) Portable scale

(76) Inventor: Howard J. Reiter, Orange, CT (US)

Correspondence Address: COOPER & DUNHAM, LLP, 30 Rockefeller Plaza, 20th Floor, NEW YORK, NY, 10112, US

(21) Appl. No.: 12/454,986

(22) Filed: May 27, 2009

(51) Int. Cl. G01G 23/18; G01G 5/04

(52) U.S. Cl. 177/45; 177/208

(57) ABSTRACT

A portable scale including an inflatable bladder, an inflation port, a pressure sensor, and a display. The display indicates the weight of an object that may be placed upon the bladder based on the pressure inside the bladder that is sensed by the pressure sensor. The bladder may be deflated for easy transport or storage. The portable scale may further include a mechanical or electric pump for inflating the bladder. The pump may be turned off when the pressure inside the bladder reaches a predetermined level.

### TECHNICAL FIELD

The present invention relates to a portable luggage scale. In particular, the invention relates to a scale that is inflatable, packable in luggage, and configured to allow a user to easily monitor the weight of a piece of luggage while packing and travelling.

### BACKGROUND OF THE INVENTION

Airlines recently have begun assessing fees for checking luggage and imposing costly penalties for checking luggage which is overweight. Frequently, travelers do not realize that their bags are overweight until they reach the ticketing counter at the airport where their luggage is weighed by airline personnel. Travelers who learn their luggage is overweight are faced with the choice of either paying a penalty or redistributing packed contents between their different pieces of luggage. Thus, there is a need for a convenient device which allows travelers to weigh their luggage both before leaving home and at their destination prior to their return home in order to speed check-in and avoid penalties and embarrassment.

Present scales available to the consumer for weighing personal luggage include the home bathroom scale type and the fish scale hanging hook type. However, the home bathroom scale requires a user to fully close the luggage and place it upright on the scale in order to read its weight due to the relatively small load platform and inconveniently located display. Such scales are usually heavy, sensitive, and not easily transportable. The fish scale type similarly requires a user to fully close the luggage before hoisting the luggage into the air with the scale's hook. Such a scale requires considerable strength on the part of the user and could cause muscle strain injuries. Both of these scale types require a user to fully close the luggage before weighing it, substantially impairing a user's ability to quickly and easily add or remove items from the luggage to reach a desired weight.

In addition, the load sensors typically used in these present scales are often expensive, increasing the cost of the scale substantially.

There is a need for an inexpensive, easy to use, lightweight, safe and packable scale on which an open piece of luggage may be placed and packed while allowing the user to easily monitor its weight during packing.

### BRIEF SUMMARY OF THE INVENTION

The present invention contemplates a portable scale which includes an inflatable bladder, an inflation port, a pressure sensor and a display. The pressure sensor and display may be mechanical or electronic. The bladder is inflated prior to use through the inflation port. During use, the pressure sensor senses the pressure inside the bladder and the display indicates the weight of an object placed upon the bladder as a function of the pressure sensed by the pressure sensor. After use, the bladder is deflated and the portable scale is easily stowed.

The portable scale may include a mechanical or electric pump. The mechanical pump may be attached to a hose connecting the mechanical pump to the inflation port or the mechanical pump may be integrally formed with the bladder. The electric pump may be attached to a hose connecting the electric pump to the inflation port. Alternatively, the user may inflate the bladder by blowing air into the tube.

The portable scale may further include controls for turning the pump on and off. The controls may be configured to turn the pump off when the pressure inside the bladder that is sensed by the pressure sensor reaches a predetermined level.

A deflation valve is provided for easily deflating the bladder for transport or stowage.

The bladder of the portable scale may also be attached directly to a piece of luggage.

### BRIEF DESCRIPTION OF THE DRAWINGS

The features of the present application can be more readily understood from the following detailed description with reference to the accompanying drawings wherein:

FIG. 1 is a perspective view of a portable scale according to the invention.

FIG. 2A shows a digital display.

FIG. 2B shows an analog display.

FIG. 3A and 3B are elevated views showing the manner of operation of the portable scale.

FIG. 4 is a graph showing the relationship between pressure inside the bladder and the weight of an object placed on the bladder.

FIG. 5 is a perspective view of a portable scale with an inflation tube.

FIGS. 6A and 6B are perspective views of a portable scale with a mechanical pump.

FIGS. 7A and 7B are perspective views of a portable scale with an electric pump.

FIG. 8 is a diagram of the operation of the control for the portable scale.

FIG. 9 is a perspective view of a portable scale according to another embodiment of the invention.

FIG. 10 is a diagram of the operation of a converter.

FIG. 11 is a perspective view of a portable scale with a deflation valve.

FIGS. 12A and 12B are perspective views of a portable scale according to another embodiment of the invention.

### DETAILED DESCRIPTION

This application provides a portable scale for displaying the weight of a piece of luggage while it is being packed by a user.

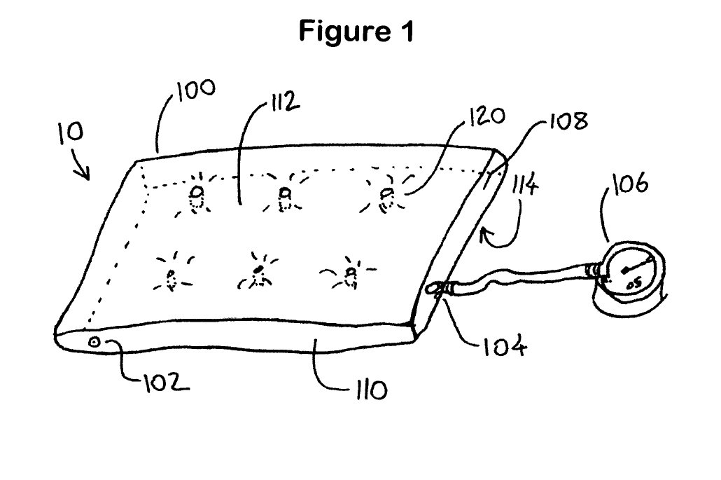

In the invention, as shown in FIG. 1, the portable scale 10 comprises an inflatable bladder 100, an inflation port 102, a pressure sensor 104, and a display 106.

The inflatable bladder 100 is configured to hold a gas, usually air, at a pressure at or above atmospheric pressure without leaking. The bladder is formed of flexible, air-tight material and sized to stably support a piece of luggage. An exemplary bladder may be formed of a vinyl material and may measure approximately thirty inches long by eighteen inches wide by four inches high when inflated.

The bladder 100 may have a shape of a rectangular prism, with side walls 108 and 110 formed perpendicularly to a top 112 and bottom 114 surfaces of the bladder 100. As shown in FIG. 1, the top 112 and bottom 114 surface of the bladder may be connected to each other, other than by the side walls 108 and 110, by one or more interior pillars 120 in order to maintain a desired shape of the bladder.

The inflation port 102, is located in a surface of the bladder 100 and allows for the inflation and optionally the deflation of the bladder 100. The inflation port 102 is configured to prevent gas from entering or leaving the bladder 100 when not inflating or deflating the portable scale. Gas may be introduced into the bladder by a user blowing air into the bladder, a mechanical pump, an electric pump, or some other external source of gas.

The pressure sensor 104 communicates with the gas inside the bladder 100. The pressure sensor 104 may be mechanical or electronic. The pressure sensor 104 senses the pressure of the gas inside the bladder 100 during preparation and use of the portable scale 10. Examples of inexpensive pressure sensors suitable for use in the portable scale of the present disclosure are well known in the art.

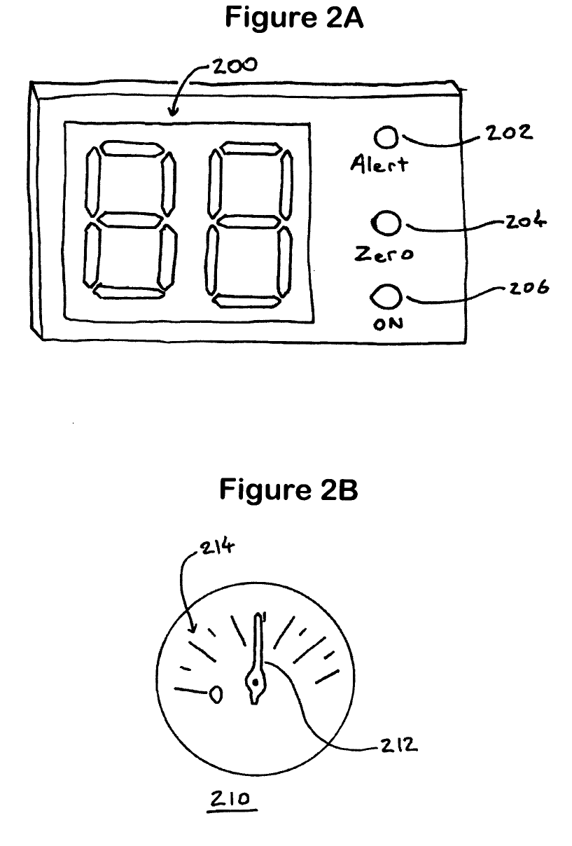

The display 106 communicates with the pressure sensor 104 and is configured to indicate the amount of weight placed on the portable scale. The display 104 may be mechanical or electronic. The display 104 also may be an electronic digital display, indicating the weight as a series of one or more integer digits. An example of a digital display, as shown in FIG. 2A, is a segmented Liquid Crystal Display 200 such as the type conventionally used in digital wrist watches. The display alternatively may be analog. An example of an analog display 210, as shown in FIG. 2B, is one that includes a movable indicator 212 which references a printed scale of weight values 214, such as a dial type display with a rotatable indicator needle.

As shown in FIG. 2A, the display also may include an audible or visual alert to alert the user that the amount of weight placed on the portable scale is at or above a predetermined alert level. This alert level may be set by the user and may correspond to the weight limit of a particular airline for a piece of luggage, as different airlines and flights to different destinations often have differing weight restrictions for luggage. An example of an audible alert is a tone or melody emitted by a speaker or piezoelectric component within the display. Examples of a visual alert include changing the color of the display, causing the display to blink, or causing a separate, discrete indicator lamp or Light Emitting Diode 202 to illuminate or blink.

As shown in FIG. 2A, the display may further comprise a zero adjustment means for adjusting the display to indicate a weight of zero when no object is placed on the bladder after it has been inflated. The zero adjustment means may, for example, comprise a movable printed scale of weight values in a mechanical display or a button 204 configured to interact with an electronic display. A zero adjustment means would reduce any inaccuracy in the displayed weight resulting from an incorrect inflation pressure.

An electronic display may also include a battery for powering the display and any alert, discussed in more detail below. The display battery may be a rechargeable type battery.

In operation of the portable scale, the pressure of a fixed amount of gas in a closed container and the volume of the container share an inverse relationship when the ambient temperature is held relatively constant. In other words, if the volume of the container decreases, the pressure of the gas increases with all other variables being held relatively constant.

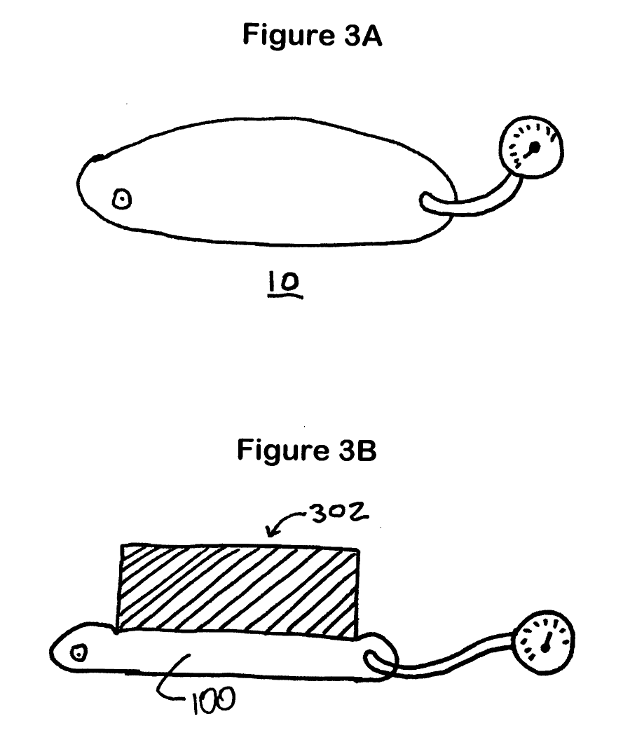

As shown in FIGS. 3A and 3B, in the portable scale 10 according to the present disclosure, when an object 302 is placed on the inflated bladder 100, the bladder's shape is compressed by the gravitational force of the object resting upon it, decreasing the volume inside the bladder 100. The decrease in volume results in an increase in pressure inside the bladder. The resulting change in pressure inside the bladder is directly related to the weight of the object placed on the bladder. Thus, the weight of the object may be determined by sensing the pressure inside the bladder.

To increase the accuracy of the display, a calibration may be performed. The calibration provides an accurate description of the pressure to weight relationship of the portable scale. This relationship may not be purely proportionate and may instead be non-linear, as factors such as the material elasticity of the bladder, the shape or structure of the bladder and the compressibility of the gas in the bladder, among other factors, may influence the pressure change to weight relationship of the portable scale. Such factors may be accounted for by performing a calibration.

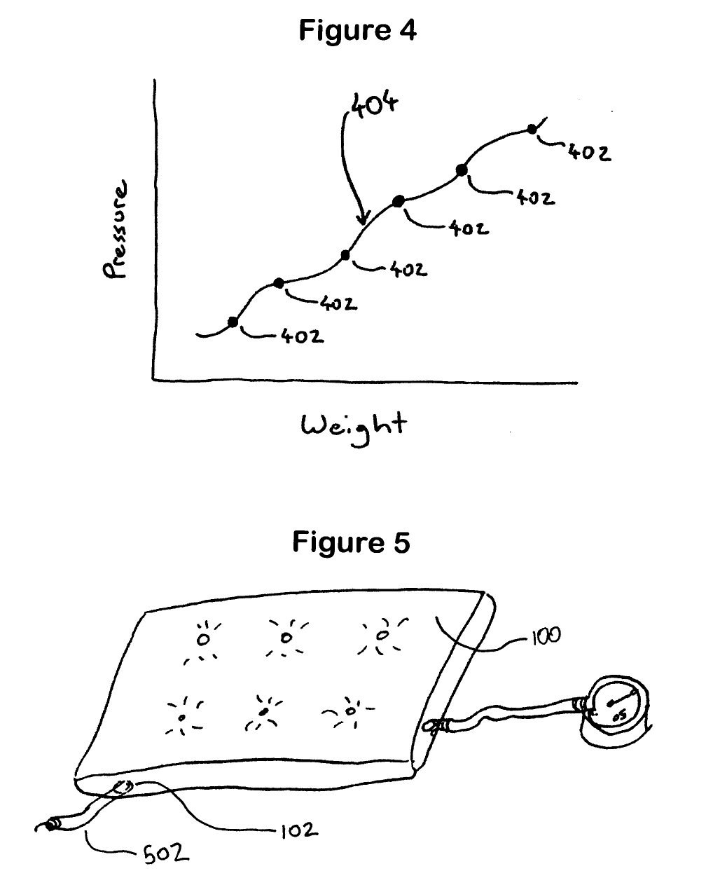

As shown in FIG. 4, one method of calibration involves placing objects of known weight on the inflated bladder and measuring the pressure inside the bladder with the pressure sensor. The pressure measurements obtained for the objects of known weight 402 are used to extrapolate a more complete relationship 404 between the measured pressure of the bladder and the amount of weight placed on the bladder. The accuracy of this calibration method may be improved by using a larger number of objects of known weight in the expected weight range of pieces of luggage to be weighed by the scale. The extrapolated relationship is then used, in the case of a mechanical gage, to print and orient a scale of weight values with calibrated locations and spacing. In the case of an electronic gage, the extrapolated relationship data may be used to configure an electronic conversion for converting signals indicating pressure from an electronic pressure sensor to signals indicating weight to be sent to an electronic display.

To use the portable scale, the user first inflates the bladder by opening the inflation port and introducing gas into the bladder until the pressure inside the bladder reaches a predetermined level, as indicated by the display. Inflating the bladder to a pressure of slightly above atmospheric pressure generally is preferable. The predetermined inflation level may be indicated by a zero weight indication on the display.

Next, the user places the inflated bladder on a hard, flat surface, places the empty piece of luggage on the bladder and begins packing it. As the user packs, a weight measurement of the piece of luggage and its contents is continuously indicated by the display. Because the weight measurement is shown on the display while the user is packing, the user is able to easily keep the weight of the piece of luggage and its contents below a desired limit without interrupting packing to close or maneuver the piece of luggage in order to acquire the weight measurement.

When the user is finished weighing the piece of luggage, the bladder may be deflated and the portable scale packed up for easy transport or storage.

There are several alternatives for introducing a gas into the bladder. As shown in FIG. 5, the portable scale may include a tube 502 attached to the inflation port 102 for allowing a user to inflate the bladder 100 by blowing air into it through the tube 502.

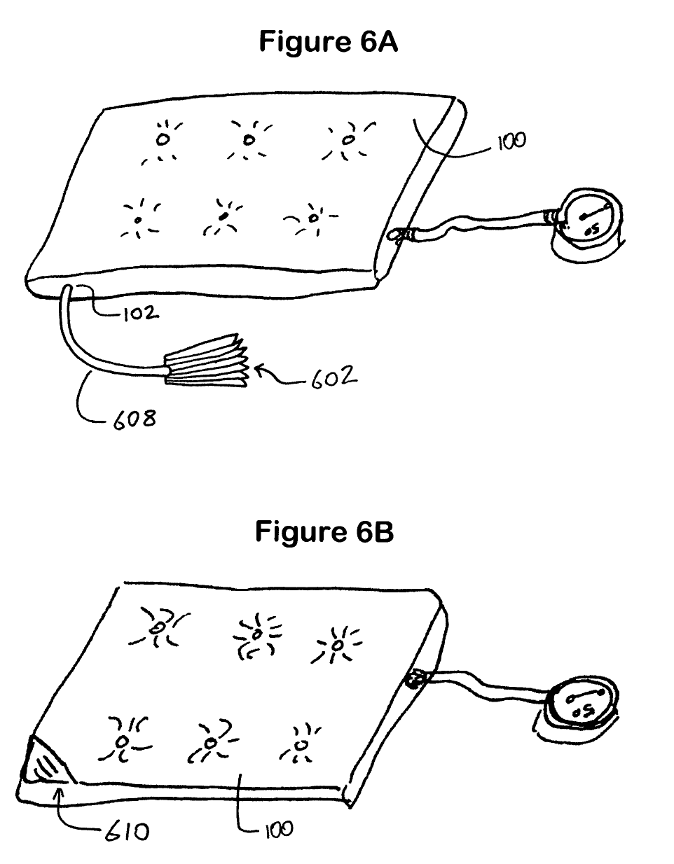

As shown in FIG. 6A, the portable scale may include a mechanical pump 602 attached to the inflation port 102 for inflating the bladder 100. The mechanical pump 602 may be attached to the inflation port 102 by a hose 608 or may be a mechanical pump 610 integrally formed with the bladder 100, as shown in FIG. 6B. The mechanical pump may be configured to be operable by the user's foot or hands.

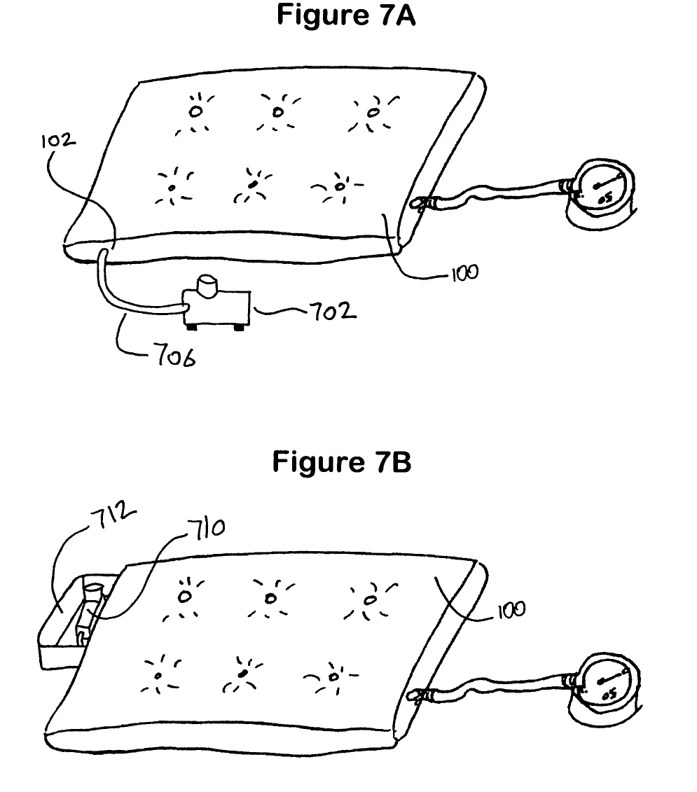

As shown in FIG. 7A, the portable scale may include an electric pump 702 for inflating the bladder 100. The electric pump 702 may be attached to a hose 706 connecting the electric pump 702 to the inflation port 102, enabling the electric pump to inflate the bladder 100 through the hose 706 while being placed at some distance away from the bladder 100. As shown in FIG. 7B, the electric pump 710 may also be contained in a compartment 712 attached to the bladder 100.

The portable scale may also include a battery for supplying power to the electric pump. The battery is desirably a rechargeable type battery. A battery charger may also be included in the portable scale for charging the rechargeable battery.

In addition to or as an alternative to a battery, the portable scale may also include a power cord and power plug for supplying the electric pump with power from a household power distribution network. To facilitate convenient use of the portable scale in countries with different power formats, power adaptors or transformers may be included as discrete components or integrally assembled in the portable scale. The electric pump may also include an electric motor configured to receive a power input in more than one format. Examples of such formats include direct current of various voltages or alternating current of various voltages and frequencies.

The electric pump may also be configured to deflate the bladder by pumping gas out of the bladder by reversing the input and output of the electric pump through a valve or other means.

The portable scale may include controls for turning the electric pump on and off. The controls may be in communication with the pressure sensor and may be configured to turn off the electric pump when the pressure sensed by the pressure sensor in the bladder reaches a predetermined level. The controls may communicate with an ON button 206, shown in FIG. 2A. When a user pushes the ON button 206, the controls turn on the electric pump.

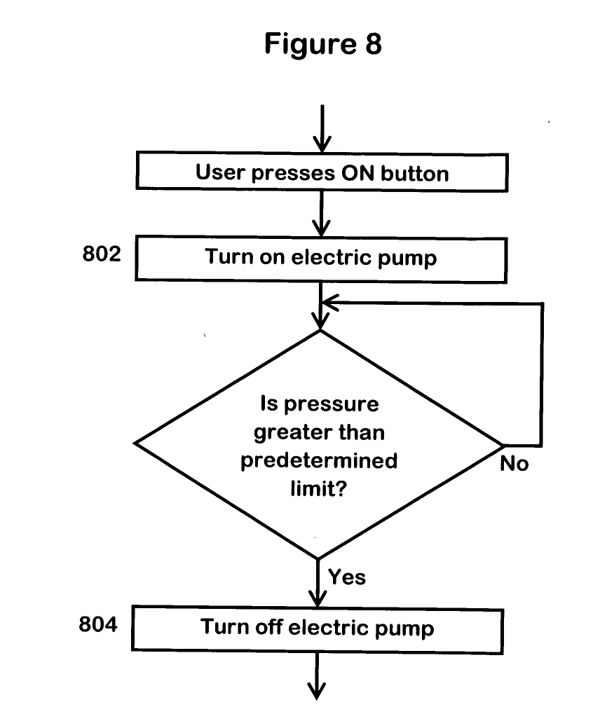

The function of the controls is shown in FIG. 8. When a user presses the ON button 206, the control turns on the electric pump 802. The control monitors the pressure inside the bladder as sensed by the pressure sensor 104. When the control detects that the pressure has reached a predetermined limit, the control turns off the electric pump 804.

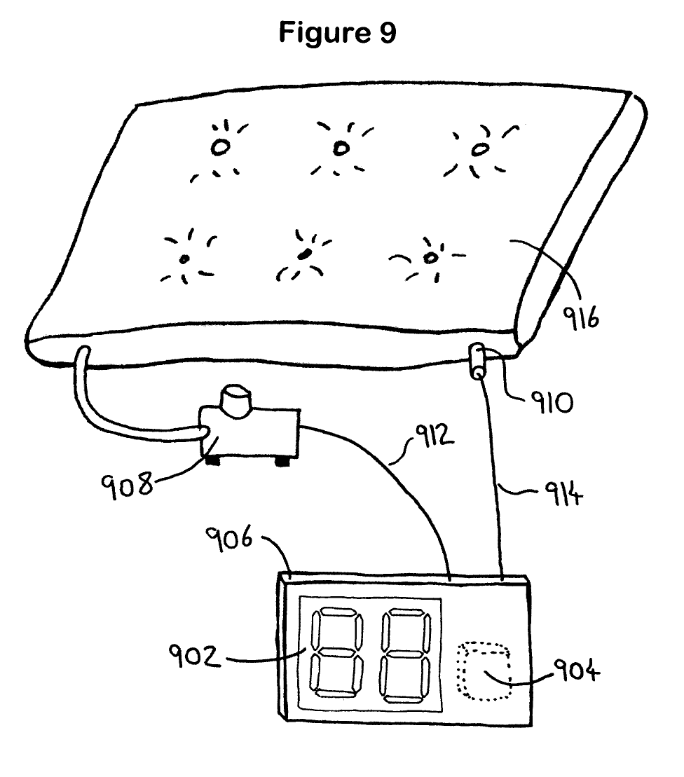

In another embodiment, the portable scale may be incorporated in a housing 906, as shown in FIG. 9. In this embodiment, the display 902 and the control 904 are provided within the housing 906. The display 902 may be a digital display. The control 904 and display 902 may be attached to the electric pump 908 and pressure sensor 910 by appropriate leads 912 and 914, enabling the housing 906 containing the control 904 and the display 902 to be placed some distance away from the bladder 916 for easier viewing and operation.

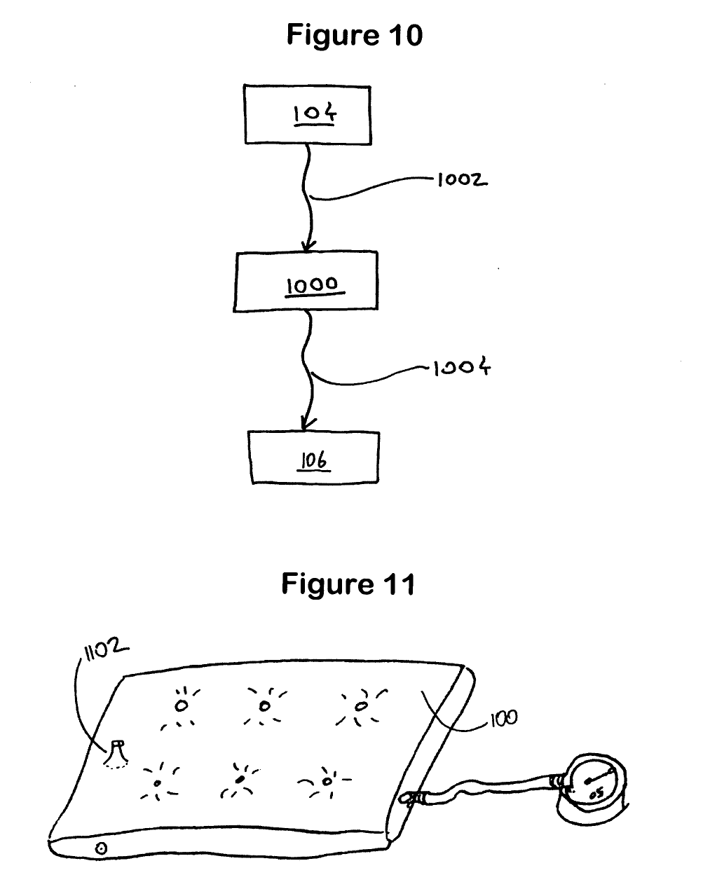

As shown in FIG. 10, the portable scale further includes a converter means 1000 for converting the pressure 1002 sensed by the pressure sensor 104 into weight 1004 that is indicated by the display 106. An example of a converter for use with a mechanical display is a printed scale of weight values with a particular orientation and spacing relative to a moveable indicator. An example of a converter for use with an electronic display is an electronic component which inputs signals from the electronic pressure sensor and converts them into signals indicating a weight measurement to send to the electronic display.

As shown in FIG. 11, the portable scale may further include a deflation valve 1102 for easily deflating the bladder 100 after use in preparation for transport or storage. Examples of a deflation valve include a valve operable by the user pushing a button and covered slit type valves conventionally used on inflatable toys, rafts, or cushions.

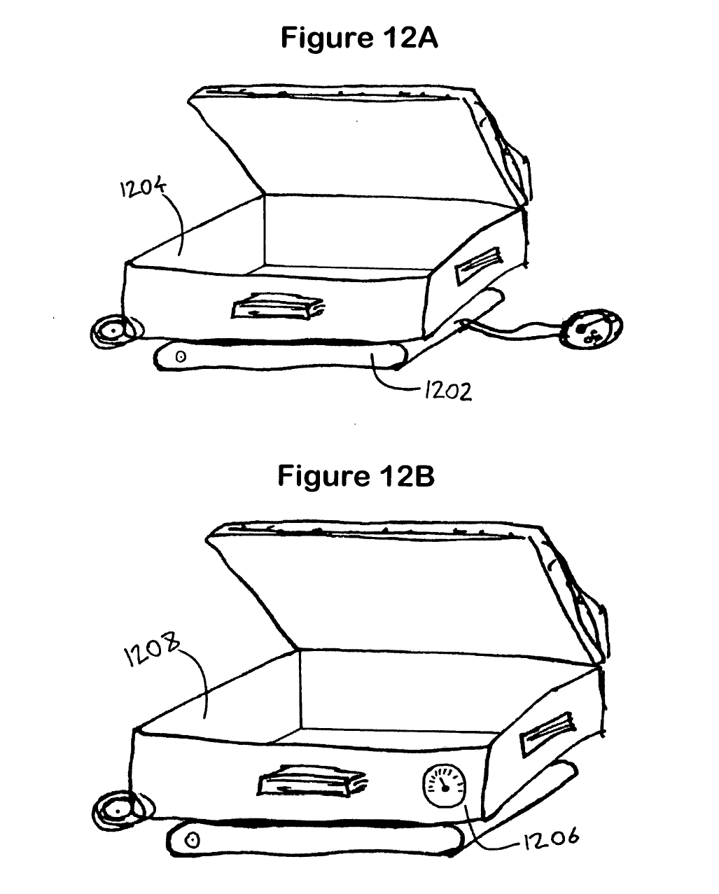

In another embodiment of the invention, as shown in FIG. 12A, at least the bladder 1202 of the portable scale is directly attached to a piece of luggage 1204. In this embodiment, the bladder 1202 may be contained within a compartment of the luggage 1204 or affixed to the exterior of the piece of luggage 1204. In this embodiment, the portable scale becomes an integral part to the piece of luggage, increasing the convenience of the scale and decreasing the chance that the scale will be forgotten at a destination and lost. The other elements of the portable scale of the first embodiment may also be attached to or concealed within the piece of luggage. In particular, and as shown in FIG. 12B, the display 1206 may be affixed to the piece of luggage 1208 in a location and orientation where it may be easily monitored by a user.

In describing examples and exemplary embodiments, specific terminology is employed for the sake of clarity in this disclosure. However, the disclosure of this patent specification is not intended to be limited to the specific terminology so selected and it is to be understood that each specific element includes all technical equivalents that operate in a similar manner.

In addition, the embodiments and examples above are illustrative, and many variations can be introduced on them without departing from the spirit of the disclosure or from the scope of the appended claims. For example, elements and/or features of different illustrative and exemplary embodiments herein may be combined with each other and/or substituted for each other within the scope of this disclosure.

What is claimed is:

1. A portable scale comprising:
a bladder;
an inflation port for introducing a gas into the bladder;
a pressure sensor in communication with the interior of the bladder for sensing pressure inside the bladder; and
a display in communication with the pressure sensor for indicating the weight of an object placed on the bladder, wherein
the weight of the object is a function of the pressure inside the bladder created by the weight of the object and that is sensed by the pressure sensor.

2. The portable scale of claim 1, further comprising a tube attached to the inflation port for inflating the bladder, the tube being configured to allow a user to introduce gas into the bladder.

3. The portable scale of claim 1, further comprising a mechanical pump attached to the inflation port for inflating the bladder.

4. The portable scale of claim 1, further comprising means for converting the pressure created by the object on the bladder into a weight measurement.

5. The portable scale of claim 1, wherein the pressure sensor is a mechanical pressure sensor and the display is a mechanical display.

6. The portable scale of claim 1, wherein the pressure sensor is an electronic pressure sensor and the display is an electronic display.

7. The portable scale of claim 1, further comprising an electric pump for inflating the bladder.

8. The portable scale of claim 1, further comprising a pump and means for turning the pump off when the pressure inside the bladder that is sensed by the pressure sensor reaches a predetermined level.

9. The portable scale of claim 1, further comprising means for alerting the user that the weight of the object placed on the bladder is equal to or more than a predetermined alert level.

10. The portable scale of claim 1, further comprising a deflation valve for deflating the bladder.

11. The portable scale of claim 1, further comprising zero adjustment means for adjusting the display to indicate a weight of zero when no object is placed upon the bladder.

12. The portable scale of claim 1, further comprising a piece of luggage, wherein the bladder is attached to a surface of the piece of luggage.

13. The portable scale of claim 12, wherein the display is attached to a second surface of the piece of luggage.

14. A portable scale comprising:
a bladder;
an inflation port for introducing a gas into the bladder;
a pump for inflating the bladder through the inflation port;
a deflation valve for deflating the bladder;
a pressure sensor in communication with the interior of the bladder for sensing the pressure inside the bladder; and
a display in communication with the pressure sensor for indicating the weight of an object placed on the bladder, wherein
the weight of the object is determined by the pressure inside the bladder created by the weight of the object and that is sensed by the pressure sensor.
